(19) United States
(12) Patent Application Publication
(10) Pub. No.: US 2026/0034566 A1
(43) Pub. Date: Feb. 5, 2026

(54) SORTING DEVICE

(71) Applicants: FRAUNHOFER-GESELLSCHAFT ZUR FÖRDERUNG DER ANGEWANDTEN FORSCHUNG E.V., München (DE); WESORT.AI GMBH, Würzburg (DE)

(72) Inventors: Johannes LEISNER, Erlangen (DE); Alexander ENNEN, Erlangen (DE); Nathanael LAIER, Würzburg (DE); Johannes LAIER, Würzburg (DE)

(21) Appl. No.: 19/357,587

(22) Filed: Oct. 14, 2025

Related U.S. Application Data
(63) Continuation of application No. PCT/EP2024/060171, filed on Apr. 15, 2024.

(30) Foreign Application Priority Data
Apr. 14, 2023 (EP) 23168070.3

(51) Int. Cl. B07C 5/34; G01N 23/083; G01N 23/12

(52) U.S. Cl. CPC B07C 5/3416; G01N 23/083; G01N 23/12; B07C 2501/0054; G01N 2223/206; G01N 2223/611

(57) ABSTRACT

Sorting device (10), comprising: conveying means (12) for conveying a material flow (14) through the sorting device (10); a multi-energy X-ray system (20) configured to radiograph the material flow (14) by using at least two different energies and to detect radiographs based on the radiography, wherein each radiograph includes, per area, first information regarding a density and/or an atomic number as well as second structural information; a processor (28) configured to detect one or several areas comprising a component to be recycled (16) or a battery, in particular a lithium-ion battery, or a battery cell, in particular a lithium-ion battery cell, in a respective one of the radiographs using an AI algorithm; wherein detecting takes place based on a first feature (M1) derived from first information and a second feature (M2) derived from the second structural information.

### CROSS-REFERENCE TO RELATED APPLICATIONS

This application is a continuation of copending International Application No. PCT/EP2024/060171, filed Apr. 15, 2024, which is incorporated herein by reference in its entirety, and additionally claims priority from European Application No. EP 23168070.3, filed Apr. 14, 2023, which is also incorporated herein by reference in its entirety.

Embodiments of the present invention relate to a sorting device or a sorting plant having a single or multi-energy X-ray system as well as to a respective method for recycling and a computer program. Embodiments relate to a system describing the combination of multi-energy X-ray technology and image evaluation based on deep learning in order to detect lithium-ion accumulators in material flows.

### BACKGROUND OF THE INVENTION

Lithium-ion accumulators (lithium-ion batteries-LIB) cause fires and enormous economic damage in sorting plants. The LIB are damaged in the mechanical processing steps of the sorting plant (e.g., bag openers or shredders) and can subsequently catch fire. The fires caused by LIB are very hard to extinguish, as high amounts of energy are released and the decomposition process of the LIB generates oxygen, which accelerates the fire or reignites already extinguished fires.

The detection of the LIB in recycling flows (e.g., yellow bag, recycling bin, paper, etc.) is anything but trivial. On the one hand, the material is frequently piled up to 20 to 30 cm high on the conveyor belts and on the other hand, the LIB are frequently installed in electronic devices and hence the same cannot be detected freely on the material flow. This fact completely excludes optical detection systems (cameras, etc.). Mechanical separating methods, such as air stream sorting, may separate heavy from light objects, but cannot detect or unload LIB without fail. The invention to be applied in this field solves the detection of LIB in complex material flows that could so far not be implemented.

So far, the problem has been tackled at its symptoms and not at the root. Sorting plants use thermographic cameras and extinguishing apparatuses in order to detect and extinguish temperature rises in the material flows. Such systems cost up to 5 million euros for individual sorting plants. On the one hand, the detection rate of the cameras for high material thicknesses on the conveyor belts is problematic, and on the other hand, the fact that the resulting extinguishing water has to be collected and disposed of separately. No other method or no other product operating in a similar manner to the suggestion herein is known.

Frequently, there are manual sorting steps at the end of the sorting plants where work persons grab objects out of the material flow, while the objects pass along on a conveyor belt. At this point, in most cases, it is much too late to react to ignited or just igniting LIB. Therefore, there is a need for an improved approach.

### SUMMARY

According to an embodiment, a sorting device may have: conveying means for conveying a material flow through the sorting device; a single or multi-energy X-ray system configured to radiograph the material flow by using at least one energy or at least two different energies and to detect radiographs based on the radiography, wherein each radiograph includes, per area, first information regarding a density and/or an atomic number as well as second structural information; a processor configured to detect one or several areas including a component to be recycled or electronics or a battery, in particular a lithium-ion battery, or battery cell, in particular a lithium-ion battery cell, in a respective one of the radiographs by using an AI algorithm; wherein detecting takes place based on a first feature derived from the first information and/or a second feature derived from the second structural information.

According to another embodiment, a method for recycling may have the steps of: conveying the material flow through a sorting device by means of conveying means; radiographing the material flow with at least two different energies and detecting radiographs based on the radiography, wherein each radiograph includes, per area, first information regarding a density and/or an atomic number as well as second structural information; detecting one or several areas including a component to be recycled or electronics or battery, in particular a lithium-ion battery, or a battery cell, such as a lithium-ion battery cell, in a respective one of the radiographs by using an AI algorithm, wherein detecting takes place based on a first feature derived from the first information and/or a second feature derived from the second structural information.

Another embodiment may have a non-transitory digital storage medium having a computer program stored thereon to perform the inventive method for recycling, when said computer program is run by a computer.

Embodiments of the present invention provide a sorting device with conveying means, a single or multi-energy X-ray system as well as a processor. The conveying means are configured to convey a material flow through the sorting device, the same can, for example, be implemented on a conveyor belt. Then, the material flow to be recycled, e.g., waste or waste from the yellow bag, is conveyed on the conveyor belt. This material flow can also include components, such as batteries or accumulators or lithium-ion batteries, that are to be specifically recycled. The single or multi-energy X-ray system is configured to radiograph the material flow by using at least one energy or two different energies and to detect radiographs based on the radiography, wherein each of the radiographs includes, per area, first information regarding a density and/or an atomic number as well as second structural information. According to embodiments, the structural information can include information regarding a location of the one or several areas of the component to be recycled/electronics/battery or battery cell or regarding a position of electronics or wiring.

Additionally or alternatively, the second structural information can include information regarding a geometry of the one or several areas of the component to be recycled or battery or battery cell. The processor is configured to detect one or several areas comprising a battery, in particular a lithium-ion battery, or a battery cell, in particular a lithium-ion battery cell, in a respective one of the radiographs by using an AI algorithm or an AI algorithm trained in advanced or during operation. Detecting takes place based on a first feature derived from the first information and/or a second feature derived from the second structural information.

Embodiments of the present invention are based on the finding that an artificial neural network (ANN) can be fed by the combination of multi-energy radiographs allowing the evaluation of radiographed materials regarding their density and atomic number as well as structural information from the radiographs (e.g., shape, attenuation, information on, for example, installed electronics . . . ) in order to allow early recognition of components to be recycled. For example, the neural network can be trained to detect devices, such as LIB (lithium-ion battery) or individual LIB (cells) within these evaluated projections. This results in the advantage that the fire hazard caused by the LIB can be eliminated already at the beginning of the recycling process. With a high detection quality, it can be assumed that the fire hazard by LIB is significantly reduced or can be completely eliminated. In contrast to other detection methods that would need a mono-position of the material flow (such as optical systems), this is not needed with the discussed approach. In most sorting plants, it would be difficult to generate a mono-position in the material flow, in particular at the beginning of the material flow. Thus, embodiments of the invention provide increased fire safety, wherein the costs for the X-ray detection system would be significantly lower than current plants for fire detection and fire extinguishing.

According to embodiments, the processor is configured to identify one or several candidate areas for the component to be recycled or for the battery or the battery cell based on the first feature and to identify the candidate areas as the one or several areas based on the second feature. According to a further embodiment, it would be possible that the one or several candidate areas for the component to be recycled, the battery or the battery cell are identified based on the second feature and the candidate areas are identified as the one or several areas based on the first feature. According to a further variation, the processor can also be configured to identify the one or several areas based on a combination of the first and second features.

According to an embodiment, the processor is configured to determine a position of the one or several areas and/or information on the position or relative position in the material flow of the one or several areas and to pass the same on to the sorting plant, for example. According to embodiments, the sorting device can comprise a control that is configured to control the sorting means. According to embodiments, controlling the sorting means takes place such that the same are activated when the processor has identified the one or several areas. According to a further variation, the control is configured to control the sorting means and to sort out the component to be recycled/the battery/the battery cell by means of the sorting means based on the previously determined position or the determined relative position. Here, the sorting means can be positioned based on the position of the one or several areas and/or information on the position or relative position of the one or several areas in the material flow.

According to embodiments, the sorting means comprise a pneumatic system, a pneumatic fast-switching valve, a driven flap, a reversing belt or a robotic gripper arm.

According to embodiments, the X-ray system is configured to determine the second structural information by analyzing a homogenous area or a quasi-homogenous area associated with a component to be recycled/battery or battery cell with regard to its geometry. Here, the geometry is detected. Cylinder-shaped geometries are typical for battery cells. It would also be possible that additional components, such as wiring or electronics, are also detected during the detection. Wirings have a high aspect ratio and frequently have an at least partly irregular bending. Electronics are characterized by a carrier, such as a printed circuit board, or electric components, such as capacitors, ICs and/or resistors. These additional components like the wiring or the electronics in combination with round, cylinder-shaped, square cells can represent the second structural information. In the simplest case, the second structural information can comprise information on the enclosed volume or the geometry associated with a component to be recycled. Here, according to embodiments, pattern detection can take place that accesses several exemplary/similar patterns in a database and detects similarities to typical patterns. According to embodiments, this database is AI-trained. By means of user input, relevant objects are labelled and the respective training data are supplied to the AI algorithm in order to train the same.

According to embodiments, training can also take place in combination with the first information, i.e., labeled training data including the first and the second structural information are included. The same are then examined by the AI algorithm regarding first and second features. Advantageously, large amounts of training data are used in order to train the AI algorithm in advance or during operation. According to embodiments, it would also be possible that the large amounts of data are collected during operation and are subsequently labeled.

According to embodiments, the X-ray system is arranged in front of the sorting means in the material flow. Regarding the position, it should be noted that the position and the relative position in the material flow is calculated and passed on along the movement of the material flow, i.e., in dependence on the direction of movement and speed of movement of the material flow. According to embodiments, the material flow can have several layers, wherein the component to be recycled/battery/battery cell does not necessarily have to be positioned on the top layer, but can also be arranged between two layers.

A further embodiment provides a method for recycling, comprising:
conveying the material flow through a sorting device by means of sorting means;
radiographing the material flow with at least one or two different energies and detecting radiographs based on the radiography, wherein each radiograph includes, per area, first information regarding a density and/or an atomic number as well as second structural information;
detecting one or several areas comprising a component to be recycled or a battery, in particular a lithium-ion battery, or a battery cell, such as a lithium-ion battery cell, in a respective one of the radiographs by using an AI algorithm,
wherein detecting takes place based on a first feature (M1) derived from the first information and/or a second feature (M2) derived from the second structural information.

### BRIEF DESCRIPTION OF THE DRAWINGS

Embodiments of the present invention will be detailed subsequently referring to the appended drawings, in which:

FIG. 1 a schematic illustration of a sorting plant according to a basic embodiment;

FIG. 2 a schematic illustration of a flow diagram for illustrating the recycling method according to embodiments;

FIG. 3 a schematic illustration of a component to be recycled (battery) for discussing first and second features or first and second (structural) information applied in embodiments.

### DETAILED DESCRIPTION OF THE INVENTION

Before embodiments of the present invention will be discussed below based on the accompanying drawings, it should be noted that equal elements and structures are provided with the same reference numbers, such that the description of the same is inter-applicable or inter-exchangeable.

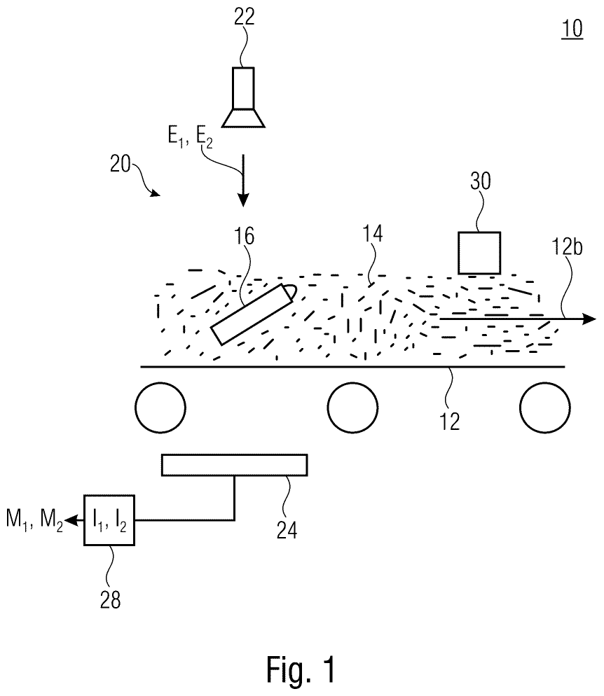

FIG. 1 shows a sorting plant 10 (generally sorting device) having conveying means 12 as well as an X-ray system, here multi-energy X-ray system 20. The same includes, for example, a radiation source 22 as well as a radiation detector 24. Above that, the sorting plant 10 includes a processor 28. The same is, for example, informationally coupled to the (multi-energy) X-ray system and receives radiographs from the X-ray detector 24. According to optional embodiments, the sorting plant 10 can also comprise sorting means 30.

The conveying means 12, here configured as conveyor belt, convey a material flow 14 along a direction of movement 12b. An object to be detected, such as a battery or lithium-ion battery 16, can be included, e.g., in the material flow 14. The sorting plant 10 is configured to identify the object 16 to be detected and to sort the same out according to optional embodiments by means of the sorting means 30. Subsequently, the identification of the object 16 will be discussed according to the basic embodiment.

The multi-energy X-ray system 20 radiographs the material flow 14 and therefore also the object 16 to be recycled by means of the radiography source 22. For this, two or more radiography energies E1 and E2 are used, which are then detected by the X-ray detector 24 after radiographing the material flow 14 or the object to be recycled 16. The X-ray detector 24 outputs the radiographs associated with the energy E1 and E2, for example, to the processor. According to a variation, the radiographs can generally be present as multi-energy radiographs or generally as radiographs. Radiographs have the advantage that information, such as a density of the object to be radiographed and hence also the material flow 14 or the object to be recycled 16 as well as an atomic number of the material flow 14 or the object to be recycled 16 can be determined. The density and/or the atomic number is considered as first information. Here, it should be noted that batteries, such as lithium-ion batteries (cf. object to be recycled 16) frequently have a specific density and/or a specific atomic number due to their materiality. This first information I1 is determined by the processor 28 or taken from the respective radiograph. As the entire material flow 14 including the object to be recycled 16 is radiographed, this information I1 can be taken from each radiograph associated with different areas, e.g., associated with different pixels or associated with differently clustered pixels. Apart from determining I1, the processor 28 is also configured to determine I2. I2 represents structural information, such as the geometry of an object 16 in the material flow 14 or the location or the position. In this regard, the processor 28 is configured to detect/mark a contiguous area, e.g., consisting of several pixels in each radiograph and to analyze this area with regard to position, location, size, geometry. For example, the geometry of the object to be recycled 16 or of the battery can be detected. Batteries frequently have a cylinder-shape. The processor 28 can detect and mark such typical geometries.

A first feature M1 is derived from the information I1 regarding the density or atomic number, while a second feature M2 is derived from the information I2 regarding the geometry or generally the structural information. These two features in combination allow conclusions on the object 16, or, in particular, on the presence or absence of a searched object 16, such as a battery, a lithium-ion battery, or battery cell, or lithium-ion battery cell. The features M1, M2 can each have different manifestations, wherein combining the manifestation according to embodiments allows detection. Detection is performed according to an AI algorithm or a trained algorithm. The algorithm is implemented on the processor 28 and is trained by means of learning data either in advance or during operation. That way, according to embodiments, the processor 28 can have access to a database, e.g., a database stored in an internal memory or in an external memory (server). An external database offers the advantage that the large database for training the AI algorithm can be increased by several linked AI algorithms or similar sorting plans.

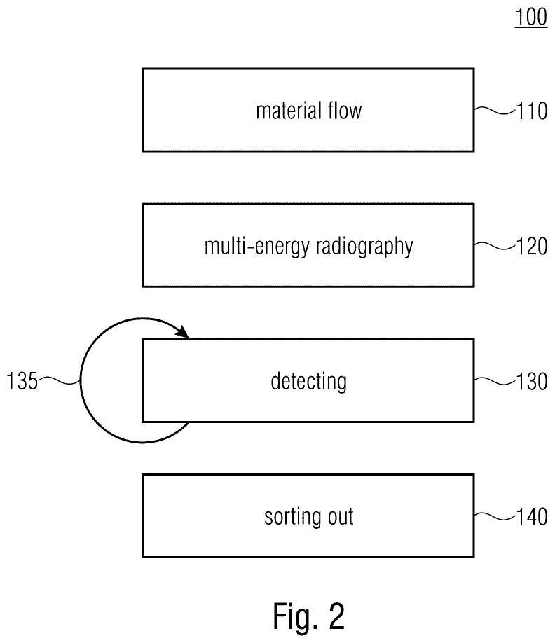

In the following, the respective method for controlling the sorting plan will be discussed with reference to FIG. 2, wherein optional steps will also be discussed.

The method 100 includes the three basic steps 110, 120, and 130. After that, an optional step 140 can be provided. In step 140, the material flow 14 including, e.g., the lithium-ion accumulator 16, is conveyed through the sorting plant 10 by means of the conveying means 12.

In the subsequent step 120, the material flow is radiographed with two different energies in order to obtain the radiographs. According to embodiments, these two steps 110 and 120 are continuously repeated, namely for ever new material flow portions, such that ever new multi-energy radiographs are captured from further or shifted portions. In the subsequent step 130, either the one multi-energy radiograph or the plurality of multi-energy radiographs associated with several samples can be analyzed. This step is provided with reference number 130 and includes detecting one or several areas comprising a component to be recycled, such as a battery, lithium-ion battery, or battery cell, lithium-ion battery cell, by using an AI algorithm. Detecting 130 takes place, as already discussed above, based on the first or second feature M1/M2. Here, the first and second features can be used in combination. The combination means that both features are equal, i.e., are evaluated together. Alternatively, evaluation according to the first feature and confirmation by the second feature or evaluation according to the second feature and confirmation by the second feature would be possible. According to further embodiments, obviously, further features can be added.

According to embodiments, each feature is characterized by one or several parameters. For the first feature, this would be the atomic number or density. Lithium-ion batteries have a specific atomic number or range within which the atomic number falls. The same can be, e.g., 3 or between 1 and 30. Exemplarily, the density can also be in a range of 0.1 to 5 g/cm³ or 0.5 g/cm³ to 12 g/cm³.

There are also parameters for the second feature M2, based on which the same can be described. For example, it can include a geometry parameter that characterizes the shape or also geometry parameters characterizing the volume. This second structural feature M2 can also include information regarding whether the component to be recycled is connected to further components, such as electronics. Both in the first and in the second feature M1/M2, a combination of sub features (in the first feature atomic number+density, in the second feature, for example volume+form factor and/or +further components detected) is possible. Based on the combination of features or combination of features of the sub features, detection will take place.

Detected objects to be recycled, such as lithium-ion batteries, are marked, i.e., information is output that there is a high probability that a respective feature to be recycled, such as lithium-ion battery, is present. Additionally, the position of the object 16 in a material flow 14 can also be indicated, wherein the position, based on the movement of the material flow 12b, can also include information regarding the speed, direction of movement, etc.

In the next optional step 140, this information is used. In step 140, the detected object 16 is sorted out accordingly, i.e., separated from the rest of the material flow 14, e.g., by a pneumatic apparatus or a gripper arm. In FIG. 1, these sorting means are provided with reference number 30.

In summary, this means that the system 10 of FIG. 1 uses multi-energy X-ray technology 20 to radiograph a waste flow 14, e.g., on a conveyor belt 12 and to detect LIB 16 in the material flow 14, even at high material thickness and in different devices. For identifying the LIB 16 (exposed or within devices), a machine-learning (ML) based approach is used. The same uses the at least first feature M1 and the second structure feature M2 or the respective sub features thereof. For this, the algorithm is trained with a plurality of learning data. This step is optional, and provided with reference number 135 in FIG. 2. During training, a plurality of multi-energy radiographs associated with different material flows or different material flows with objects to be detected, such as LIB, are provided, and labeled in advance or afterwards.

In that way, classification of the individual differing materials in the material flow 14 and hence, also detection of the LIB 16 or generally, the object to be detected 16 based on the features M1 and M2 is possible. The first feature M1 is determined based on the first information, while the feature M2 is determined based on the second structural information. As already mentioned above, also several pieces of information can be used for each feature M1 and M2. It is also possible that each feature is divided into sub features.

According to embodiments, the ML processor or processor trained by ML 28 classifies the found devices 16 into classes (such as power banks, mobile phones, etc.) according to further embodiments. This means that a differentiation between individually detected objects 16 can also take place. In that way, the algorithm can also be configured such that different objects are detected and distinguished. This also takes place by linking the information from the multi-energy radiographs (X-ray data based on density and atomic number) with the object detection (shape, attenuation, information, for example, on installed electronics, etc.).

Here, it should be noted that according to embodiments, the multi-energy radiography technology is installed in the sorting plant as far to the front as possible in the material flow direction (cf. 12b), in order to detect dangerous elements, such as LIBs, as early as possible.

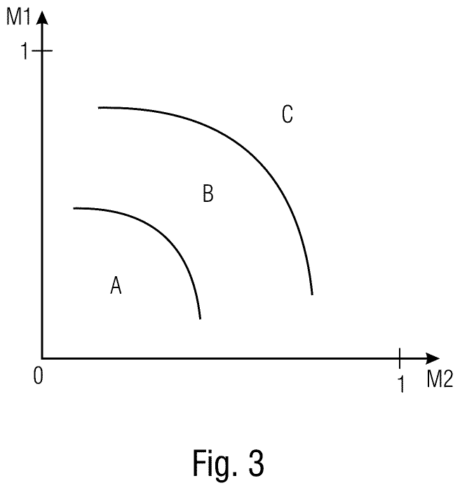

With regard to FIG. 3, feature combinations will be discussed based on a diagram. FIG. 3 shows a two-dimensional diagram with the features M1 and M2. The higher the value, the higher the level of compliance of the respective feature. For example, a high M1 value indicates that the atomic number and/or the density is close to a typical density/typical atomic number for objects to be searched, such as LIB. With the feature M2, the combination of different form factors is determined. For example, a high M2 value indicates that the size is within the range of the respective sort for value, i.e., for example, that the detected object has a respective volume that corresponds to a volume of a searched object, such as an LIB, i.e., is not significantly greater or significantly smaller. The diagram is divided into three parts, wherein the diagram part A indicates that probably no LIB is present in the examined area, and the diagram part B indicates an average probability. In the area C, the probability that an LIB has been found in the examined area is high. According to further embodiments, the individual features, such as the second structural feature M2 can also be divided, such that, for example, a multi-dimensional, e.g., three-dimensional feature space results.

As already mentioned above, a comparison with a typical “target value” is made for the feature i.e., that the probability that a respective searched object, such as an LIB, is present, is given when the atomic number or density is extremely high.

Here, it should be noted that, according to embodiments, the multi-energy radiograph can be realized not only by one-dimensional radiography, i.e., also not only in one radiography direction but also a multi-dimensional radiography direction, according to a CT.

In the following, an embodiment will be discussed in its entirety:

A multi-energy X-ray system is installed at a suitable position in the sorting plant (as early as possible). The same radiographs the material flow on the conveyor belt and generates radiographs. These radiographs allow the evaluation of the radiographed material regarding its density and atomic number, as well as feeding of structural information from the radiographs (shape, attenuation, information, e.g., on installed electronics, . . . ) into an artificial neural network (ANN). This neural network is trained to identify devices with LIB or individual LIB in these evaluated projections. Thus, the LIB can be detected, found and sorted out of the material flow at an early stage in the recycling process. For sorting out, different methods (e.g., a pneumatic fast-switching valves, driven flaps, a reversing belt or a (robotic) grippers, etc.) can be used.

Embodiments of the present invention are mainly used in the recycling industry. Here, different material flows within the sector can be addressed. These are, for example, the material flow of light weight packaging, electrical waste and electronic equipment (WEEE), industrial or municipal waste. Additionally, it would also be possible to transfer the patent to other fields of application, such as the detection of LIB in paper waste. This does not only concern sorting plants, but also, e.g., processing plants for paper, temporary storages or plants for pressing bales.

Although some aspects have been described in the context of an apparatus, it is obvious that these aspects also represent a description of the corresponding method, such that a block or device of an apparatus also corresponds to a respective method step or a feature of a method step. Analogously, aspects described in the context of a method step also represent a description of a corresponding block or detail or feature of a corresponding apparatus. Some or all of the method steps may be performed by a hardware apparatus (or using a hardware apparatus), such as a microprocessor, a programmable computer or an electronic circuit. In some embodiments, some or several of the most important method steps may be performed by such an apparatus.

Depending on certain implementation requirements, embodiments of the invention can be implemented in hardware or in software. The implementation can be performed using a digital storage medium, for example a floppy disk, a DVD, a Blu-Ray disc, a CD, an ROM, a PROM, an EPROM, an EEPROM or a FLASH memory, a hard drive or another magnetic or optical memory having electronically readable control signals stored thereon, which cooperate or are capable of cooperating with a programmable computer system such that the respective method is performed. Therefore, the digital storage medium may be computer readable.

Some embodiments according to the invention include a data carrier comprising electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer.

The program code may, for example, be stored on a machine readable carrier.

Other embodiments comprise the computer program for performing one of the methods described herein, wherein the computer program is stored on a machine readable carrier. In other words, an embodiment of the inventive method is, therefore, a computer program comprising a program code for performing one of the methods described herein, when the computer program runs on a computer.

A further embodiment of the inventive method is, therefore, a data carrier (or a digital storage medium or a computer-readable medium) comprising, recorded thereon, the computer program for performing one of the methods described herein. The data carrier, the digital storage medium, or the computer-readable medium are typically tangible or non-volatile.

A further embodiment of the inventive method is, therefore, a data stream or a sequence of signals representing the computer program for performing one of the methods described herein. The data stream or the sequence of signals may, for example, be configured to be transferred via a data communication connection, for example via the Internet.

A further embodiment comprises processing means, for example a computer, or a programmable logic device, configured to or adapted to perform one of the methods described herein.

A further embodiment comprises a computer having installed thereon the computer program for performing one of the methods described herein.

A further embodiment in accordance with the invention includes an apparatus or a system configured to transmit a computer program for performing at least one of the methods described herein to a receiver. The transmission may be electronic or optical, for example. The receiver may be a computer, a mobile device, a memory device or a similar device, for example. The apparatus or the system may include a file server for transmitting the computer program to the receiver, for example.

In some embodiments, a programmable logic device (for example a field programmable gate array, FPGA) may be used to perform some or all of the functionalities of the methods described herein. In some embodiments, a field programmable gate array may cooperate with a microprocessor in order to perform one of the methods described herein. Generally, the methods are performed by any hardware apparatus. This can be a universally applicable hardware, such as a computer processor (CPU) or hardware specific for the method, such as ASIC.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. Sorting device (10), comprising:
conveying means (12) for conveying a material flow (14) through the sorting device (10);
a single or multi-energy X-ray system (20) configured to radiograph the material flow (14) by using at least one energy or at least two different energies and to detect radiographs based on the radiography, wherein each radiograph includes, per area, first information regarding a density and/or an atomic number as well as second structural information;
a processor (28) configured to detect one or several areas comprising a component to be recycled (16) or electronics or a battery, in particular a lithium-ion battery, or battery cell, in particular a lithium-ion battery cell, in a respective one of the radiographs by using an AI algorithm;
wherein detecting takes place based on a first feature (M1) derived from the first information and/or a second feature (M2) derived from the second structural information.

2. Sorting device (10) according to claim 1, wherein detection takes place based on the first feature (M1) in combination with the second feature (M2).

3. Sorting device (10) according to any one of the preceding claims, wherein the second structural information includes information regarding a location of the one or several areas of the component to be recycled (16) or the battery or the battery cell regarding a location of electronics or wiring; and/or
wherein the second structural information includes information regarding a geometry of the one or several areas of the component to be recycled (16) or the battery or the battery cell.

4. Sorting device (10) according to any one of the preceding claims, wherein the processor (28) is configured to identify one or several candidate areas for the component to be recycled (16) or the battery or the battery cell based on the first feature (M1) and to identify the candidate areas as the one or several areas based on the second feature (M2).

5. Sorting device (10), wherein the processor (28) is configured to identify one or several candidate areas for the component to be recycled (16) or the battery or the battery cell based on the second feature (M2) and to identify the candidate areas as the one or several areas based on the first feature (M1).

6. Sorting device (10) according to any one of the preceding claims, wherein the processor (28) is configured to identify the one or several areas based on a combination of the first and second feature (M2).

7. Sorting device (10) according to any one of the preceding claims, wherein the processor (28) is configured to determine a position of the one or several areas and/or information on the position or relative position of the one or several areas in the material flow (14).

8. Sorting device (10) according to any one of the preceding claims, further comprising a control configured to control sorting means.

9. Sorting device (10) according to claim 8, wherein the control is configured to activate the sorting means when the processor (28) has identified the one or several areas.

10. Sorting device (10) according to claim 8, further comprising a control that is configured to control sorting means and to sort out the component to be recycled (16) or the battery or the battery cell by means of the sorting means, based on the determined position or determined relative position, and/or to position the sorting means based on a position of the one or several areas and/or information on the position or relative position of the one or several areas in the material flow (14).

11. Sorting device (10) according to one of claims 8, 9, and 10, wherein the sorting means comprise a pneumatic system, a pneumatic fast-switching valve, a driven flap, a reversing belt or a robotic gripper arm.

12. Sorting device (10) according to any one of claim 8, 9, 10 or 11, wherein the single or multi-energy X-ray system (20) is arranged in front of the sorting means in material flow direction.

13. Sorting device (10) according to any one of claims 7 to 12, wherein the processor (28) is configured to calculate the position or relative position in the material flow (14) along the movement of the material flow (14).

14. Sorting device (10) according to any one of the preceding claims, wherein the material flow (14) has several layers; and/or wherein the component to be recycled (16) or the battery or the battery cell is arranged between two layers.

15. Method (100) for recycling, comprising:
conveying (110) the material flow (14) through a sorting device (10) by means of conveying means (12);
radiographing (120) the material flow (14) with at least two different energies and detecting radiographs based on the radiography, wherein each radiograph comprises, per area, first information regarding a density and/or an atomic number as well as second structural information;
detecting (130) one or several areas comprising a component to be recycled (16) or electronics or battery, in particular a lithium-ion battery, or a battery cell, such as a lithium-ion battery cell, in a respective one of the radiographs by using an AI algorithm,
wherein detecting takes place based on a first feature (M1) derived from the first information and/or a second feature (M2) derived from the second structural information.

16. Computer program for performing the method steps according to the method of claim 15.
